(19) United States
(12) Patent Application Publication
(10) Pub. No.: US 2009/0219383 A1
(43) Pub. Date: Sep. 3, 2009

(54) IMAGE DEPTH AUGMENTATION SYSTEM AND METHOD

(76) Inventor: Charles Gregory PASSMORE, San Diego, CA (US)

Correspondence Address: DALINA LAW GROUP, P.C., 7910 IVANHOE AVE. #325, LA JOLLA, CA, 92037, US

(21) Appl. No.: 12/341,992

(22) Filed: Dec. 22, 2008

Related U.S. Application Data
(60) Provisional application No. 61/016,355, filed on Dec. 21, 2007.

(51) Int. Cl. H04N 13/00

(52) U.S. Cl. 348/44; 348/E13.001

(57) ABSTRACT

Image depth augmentation system and method for providing three-dimensional views from a two-dimensional image. Depth information is assigned by the system to areas of a first image via a depth map. Foreground objects are enlarged to cover empty areas in the background as seen from a second viewpoint at an offset distance from a first viewpoint of the first image. The enlarged objects are used to regenerate the first image and to generate the second image so that empty background areas are covered with the enlarged foreground objects. The resulting image pair may be viewed using any type of three-dimensional encoding and viewing apparatus. Can use existing masks from non-3D projects to perform depth augmentation and dither mask edges to provide for realistic soft edges for depth augmented objects.

This application claims benefit of U.S. Provisional Patent Application Ser. No. 61/016,355 filed 21 Dec. 2007 the specification of which is hereby incorporated herein by reference.

### BACKGROUND OF THE INVENTION

1. Field of the Invention

Embodiments of the invention described herein pertain to the field of computer systems. More particularly, but not by way of limitation, one or more embodiments of the invention enable an image depth augmentation system and method for providing three-dimensional views from a two-dimensional image.

2. Description of the Related Art

An image captured in a single photograph with a single lens camera produces a two-dimensional image. The depth information from the three-dimensional environment from which the image is captured is forever lost once the image is captured. Stereoscopically capturing two slightly offset images allows for the capturing of depth information and also allows for subsequent three-dimensional viewing of a scene captured with offset images. The two images may be captured either simultaneously with a two lens camera, with two cameras at an offset from one another, or sequentially in time with one camera via displacement of the camera after the first image capture for example.

There are many differing methods utilized for displaying three-dimensional views of two images captured at an offset from one another. Stereoscopic viewers allow for three-dimensional viewing by showing separate images to each eye of an observer. The separate display of two offset images to each eye respectively may be performed in numerous ways. The display of a two images overlaid with one another with left and right eye encoded colors in the form of an anaglyph is one such method. Viewing anaglyphs requires that observers wear specialized glasses with differing colors on each lens. Another method involves showing polarized images to each eye wherein an observer wears polarized lenses over each eye that differ in polarization angle. Yet another method of viewing independent images in each eye involves shutter glasses, such as LCD shutter glasses for example that allow for the transmission of images to each eye independently. Other types of three-dimensional viewers include autostereoscopic viewers that do not require special glasses. Autostereoscopic viewers use lenticular lenses or parallax barriers for example to provide separate images for each eye. Some displays actually track the eye of the viewer to adjust the displayed images to track the eye's of a viewer as the viewer moves. There are advantages and disadvantages to each system with respect to quality and cost.

Regardless of the type of three-dimensional viewing involved, when two separate images are originally captured at a given offset, all necessary information is present to allow for correct viewing of a scene in three-dimensions. When a single image is captured, the generation of a second image from a second viewpoint at an offset with respect to the first image results in the display of empty background areas. This is true since the second viewpoint shows background information that has not been captured, as that portion of the background was obstructed during the capture of the first image from the first viewpoint. For example, by observing an object in the foreground with one's right eye open and left eye closed, portions of the background behind the foreground object are obstructed. This environmental information is not captured and hence not available when recreating an image for the left eye with objects shifted to locations where they would be expected for the left eye. These empty background areas are required for proper viewing from the left eye however.

Since there are so many pictures and motion pictures that have been recorded in non-stereoscopic format, i.e., one image per capture, there is a large market potential for the conversion of this data into three-dimensional format.

In addition, large sets of digital masks exist for movies that have been colorized wherein the masks are available but not utilized for generation of three-dimensional images. Use of existing masks from colorization projects to augment images and movies depth, i.e., conversion from two-dimensions to three-dimensions has not been contemplated before. In addition, the merging and splitting of these masks to facilitate depth augmentation hence also not been contemplated before. Furthermore, the edges of these masks (or any other masks utilized for depth augmentation) are not known to be dithered with various depths on the edges of the masked objects to make the objects look more realistic.

Existing implementations exist for the creation of three-dimensional wire frame models for images that are animated for motion pictures, yet these systems fail to deal with artifacts such as missing image data as described above. Other systems attempt to hide border problems and round edges for example to hide this type of error. There is no previously known adequate solution to this problem. Hence, there is a need for an image depth augmentation system and method.

### BRIEF SUMMARY OF THE INVENTION

One or more embodiments of the invention enable an image depth augmentation system and method for providing three-dimensional views of a two-dimensional image. Depth information is assigned by the system to areas of a first image via a depth map. Foreground objects are enlarged to cover empty areas in the background as seen from a second viewpoint at an offset distance from a first viewpoint of the first image. The enlarged objects are used to regenerate the first image and to generate the second image so that empty background areas are covered with the enlarged foreground objects. The resulting image pair may be viewed using any type of three-dimensional encoding and viewing apparatus.

In one or more embodiments of the invention, multiple images from a sequence of images may be utilized to minimize the amount of enlargement necessary to cover empty background areas. For example, in a scene from a motion picture where a foreground object moves across a background, it is possible to borrow visible areas of an image from one frame and utilize them in another frame where they would show as empty background areas from a second viewpoint. By determining the minimum enlargement required to cover any empty background areas and scaling a foreground object by at least that factor throughout the scene, the entire scene may be viewed as if originally shot with a stereoscopic camera. Although the relative size of a foreground object in this exemplary scenario may be slightly larger than in the original image, the observer is generally unaware. In the converse scenario where the empty background areas are not covered, observers are quick to detect visual errors and artifacts, which results in a poor impression of the scene.

One or more embodiments of the invention may utilize feathering of the edges of areas in the image to provide for smooth transitions to other depths within the image. In addition, edge smoothing may be utilized over a sequence of images such as a motion picture to prevent scintillation for example. Feathering is also known as vignetting wherein the border of an area is blended with the background image over a transitionary distance, e.g., number of pixels. In other embodiments of the invention, transparency along the edges of an area may be utilized in combination with a depth gradient to produce a three-dimensional feathering functionality. For example, this allows for more natural appearance of hair or leaves where masking these objects individually would require great effort. Gradients for depth allows for walls at an angle to appear to proper travel to and away from the observer. Gradients may be accepted into the system in any form, such as linear, or curved in any form to quickly allow for the representation of depth in a two-dimensional image. By accepting fixed distances and gradients into a depth map, the system allows for the creation of a grey-scale depth map that may be used to display and further assign depths for all areas of an image. The depth may be positive in which case the offset relates to a distant object, or negative in which case the offset relates to an object in front of the display screen.

Embodiments of the invention also allow for any type of graphical effect including erosion or dilation for example. Any other graphical effect may also be utilized with embodiments of the invention. For example, motion of the two viewpoints to and away, across or around a scene may be performed by adjusting the calculated viewpoints. In this manner, a simulated camera pan resulting in a three-dimensional viewing of an image as a sequence of images is performed. All parameters related to the cameras may be calculated and altered using embodiments of the invention. This allows for different focal lengths, camera displacements and offsets to be utilized when generating output images. In any embodiments of the invention, when empty background areas would result from one or more camera viewpoints, foreground objects (anything in front of infinity for example), may be enlarged to cover these empty areas wherein the foreground objects may be maintained in their enlarged size for an entire scene for example. Depths for areas of an image may also be animated over time, for example when a character or object moves towards or away from the camera. This allows for motion pictures to maintain the proper depth visualization when motion occurs within a scene.

### BRIEF DESCRIPTION OF THE DRAWINGS

The above and other aspects, features and advantages of the invention will be more apparent from the following more particular description thereof, presented in conjunction with the following drawings wherein:

FIG. 1 is a single image to be augmented for three-dimensional viewing.

FIG. 2 is a depth map showing close objects in higher luminance grey-scale and far objects in lower luminance grey-scale and in addition, showing objects that have varying depths as gradient luminance grey-scale areas.

FIG. 3 is a view of an embodiment of the invention implemented as a computer software module that depicts the image of FIG. 1 as augmented with depth via FIG. 2 and as shown with a left and right viewpoint wherein rays from given depths are illustrated as projecting to the next farther depth.

FIG. 4 shows a view of the image viewed in FIG. 3 rotated to the right to further illustrate the depths of various areas assigned to the image.

FIG. 5 shows a view of the image viewed in FIG. 3 rotated down to further illustrate the depths of various areas assigned to the image.

FIG. 6 shows a view of the image viewed in FIG. 3 rotated to the left to further illustrate the depths of various areas assigned to the image.

FIG. 7 shows a second image with foreground objects of the first image shifted and enlarged to cover empty areas shown as ray intersections in the various depths as per FIGS. 3-6.

FIG. 8 shows the upper left quadrant of an alternate output format where the first and second images form a pair of offset images that are overlaid onto one another with varying colors in the form of an anaglyph.

FIG. 9 shows a flowchart for an embodiment of the method.

FIG. 10 shows a foreground object with empty background area before scaling and translating the foreground object to cover the empty background area.

FIG. 11 shows an image frame from a movie with masks shown in different colors imposed on a grey-scale underlying image.

FIG. 12 shows the image frame from FIG. 11 without the underlying grey-scale image, i.e., shows the opaque masks.

FIG. 13 shows the merge of the masks of FIG. 12 into one image for application of depth primitives on and tracking of the mask through frames in a scene.

FIG. 14 shows an image frame from a movie with masks shown in different colors imposed on a grey-scale underlying image.

FIG. 15 shows the opaque masks of FIG. 14.

FIG. 16 shows the selection of an area to split masks in.

FIG. 17 shows the selection of an area of the opaque masks of FIG. 16.

FIG. 18 shows the split mask imposed on the grey-scale underlying image.

FIG. 19 shows the split mask assigned to a different depth level that the other faces in the figure.

FIG. 20 shows a dithered depth edge of a flower for more realistic viewing.

### DETAILED DESCRIPTION

An image depth augmentation system and method for providing three-dimensional views of a two-dimensional image will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

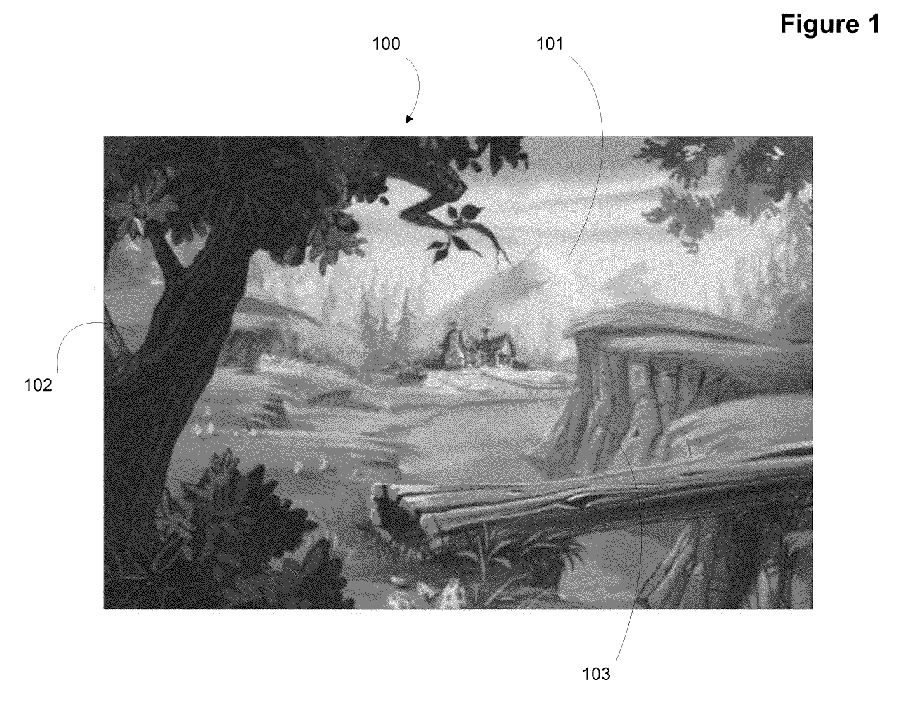

FIG. 1 shows single image 100 to be augmented for three-dimensional viewing. In this image, the human mind interprets hazy mountains 101 in the background as being distant and tree 102 in the left foreground as being close to the observer. However, no true depth is viewed since there is only one image shown to both eyes of the observer. Cliff 103, has areas that the human mind would readily interpret as having differing depths away from the observer. Embodiments of the invention are utilized in generating a second image at a second viewpoint offset from the viewpoint utilized in capturing image 100. Furthermore, embodiments of the invention are utilized to enlarge foreground objects to cover empty background areas that would be observed from the second viewpoint if the foreground objects were not enlarged. Although the relative size of a foreground object in this exemplary scenario may be slightly larger than in the original image, the observer is generally unaware of the modification.

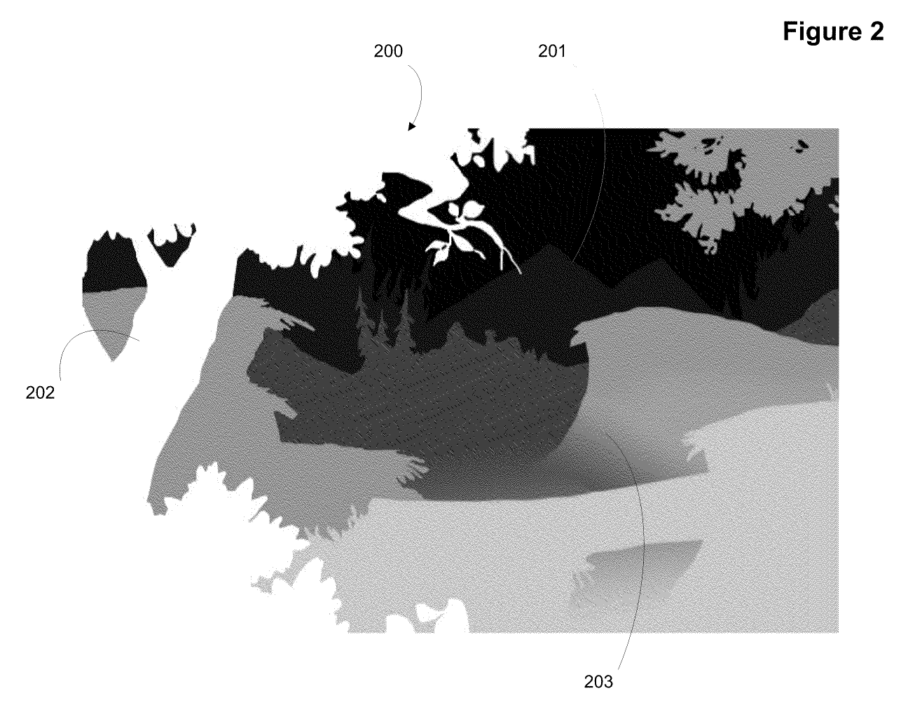

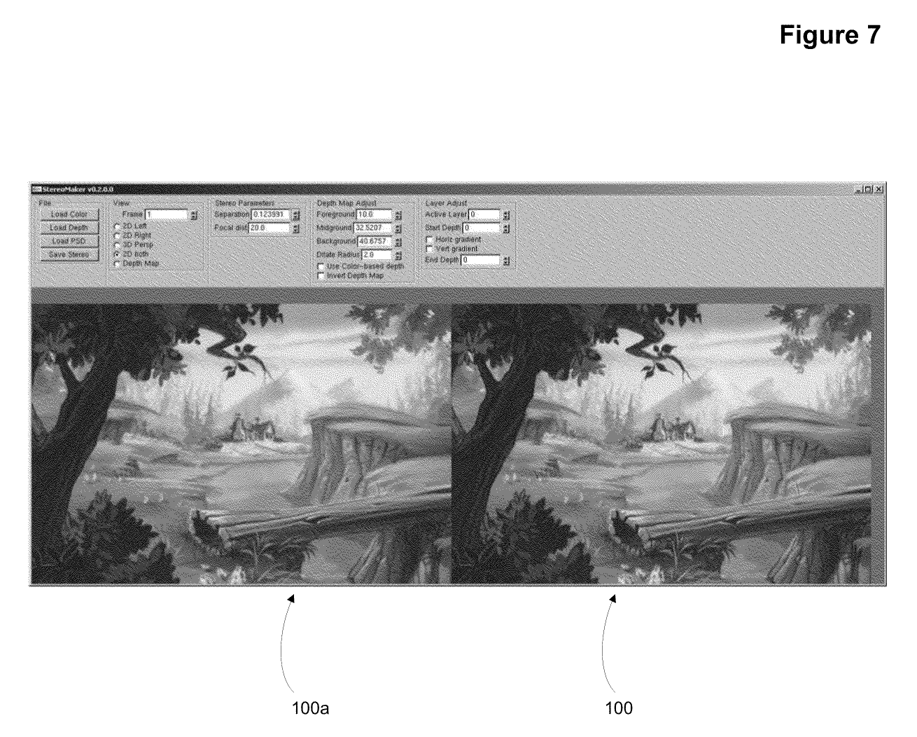

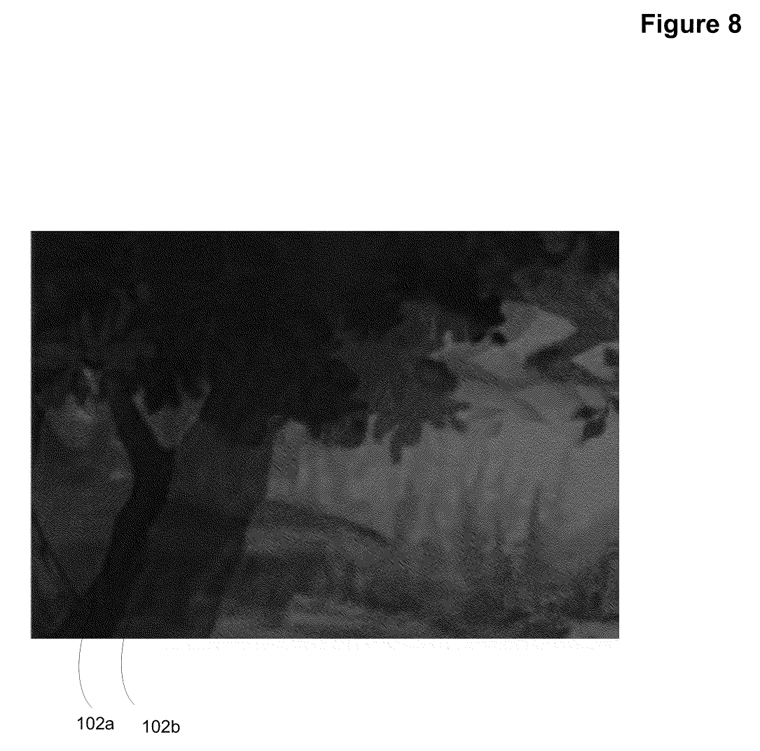

FIG. 2 shows depth map 200 showing near objects as areas in higher luminance grey-scale and far objects in lower luminance grey-scale and in addition, objects that have varying depths are shown as gradient luminance grey-scale areas. Specifically, hazy mountains 101 are shown as dark areas 201, i.e., lower luminance grey-scale value and tree 102 is shown as a light area 202, i.e., higher luminance grey-scale value. Areas with varying distance from the observer, such as area 203 are shown as gradients wherein the grey-scale varies in the area as per cliff 103. In one or more embodiments of the invention, foreground objects such as tree 102 are enlarged to cover empty areas in the background as seen from a second viewpoint at an offset distance from a first viewpoint of the first image. The enlarged objects are used to regenerate the first image and to generate the second image so that empty background areas are covered with the enlarged foreground objects. The resulting image pair may be viewed using any type of three-dimensional encoding and viewing apparatus. (See FIGS. 7 and 8 for example). Embodiments of the invention allow for the import of depth map 200, or creation of depth map 200 via any image outline detection method, or the manual entry or modification of depth via line and spline drawing and editing functionality.

In one or more embodiments of the invention, multiple images from a sequence of images may be utilized to minimize the amount of enlargement necessary to cover empty background areas. For example, in a scene from a motion picture where a foreground object moves across a background, it is possible to borrow visible areas of an image from one frame and utilize them in another frame where they would show as empty background areas from a second viewpoint. In this particular example if the viewpoint of camera is translated to the right during a scene, this translation exposes more area behind tree 102. Once the thickness of a empty background area is calculated, the ratio of the width of empty background area with respect to the center point of the foreground object is added to the distance from the center of the foreground object divided by the distance from the center of the foreground object to the edge where the empty background appears to yield a enlargement factor for the foreground object. Any other method of iterative or formulaic calculation of the enlargement factor may be utilized with embodiments of the invention. Once scaled, the foreground object is applied to the entire scene which may then be viewed as if originally shot with a stereoscopic camera. Although the relative size of a foreground object in this exemplary scenario may be slightly larger than in the original image, the observer is generally unaware. In the converse scenario where the empty background areas are not covered, observers are quick to detect visual errors and artifacts, which results in a poor impression of the scene.

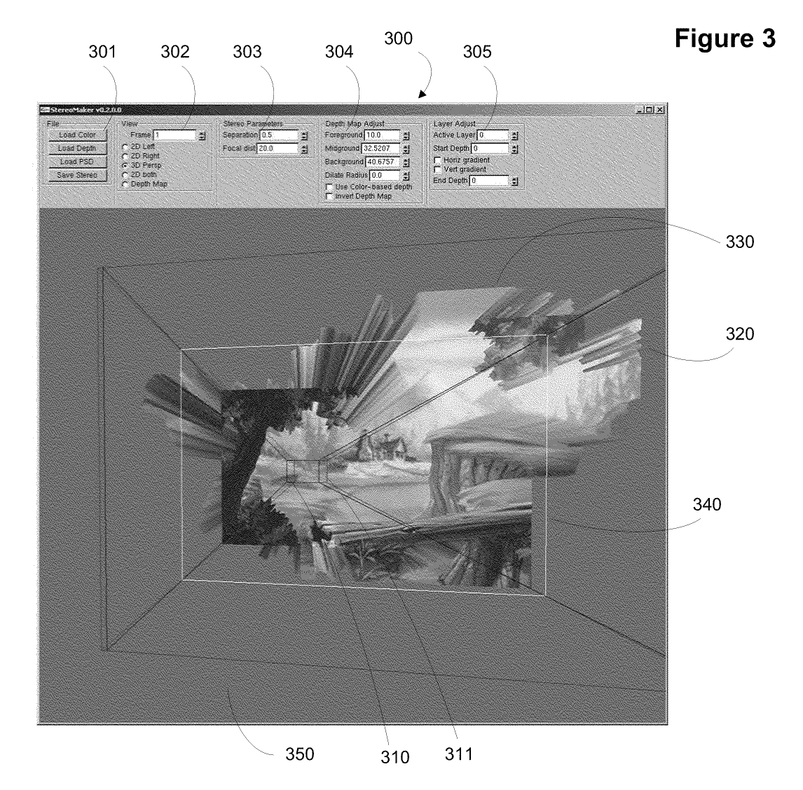

FIG. 3 is a view of an embodiment of the invention implemented as computer software module 300 that depicts the image of FIG. 1 as augmented with depth via FIG. 2 and as shown with left viewpoint 310 and right viewpoint 311 wherein rays 320 from given depths are illustrated as projecting to the next further plane 330 for example. Zero depth plane 340 shows a plane behind the objects that are to be depicted in front of the viewing screen. One or more embodiments of the system allow for the dragging of areas to and away from the user via a mouse for example to automatically move areas in depth. The system may automatically update depth map 200 in these embodiments. In other embodiments, the depth map may be viewed an altered independently or with real-time updates to the image shown in viewing pane 350.

File pane 301 shows graphical user interface elements that allow for the loading of files/depth maps and saving of output images for three-dimensional viewing. View pane 302 allows for the display of the left, right, perspective, side-by-side (e.g., “both”), and depth map in viewing pane 350. Stereo pane 303 allows for the setting of camera parameters such as separation and focal distance. Depth pane 304 allows for the setting of distances for the foreground, midground (or zero depth plane) and background for quick alteration of depth map 200 related parameters. Furthermore, the dilate radius may also be set in depth pane 304. Layer pane 305 allows for the alteration of the active layer and horizontal and vertical gradients with starting and ending depths within each layer.

Other tools may be utilized within depth map 200 or viewing pane 350. These tools may be accessed via popup or menu for example. One or more embodiments of the invention may utilize feathering of the edges of areas in the image to provide for smooth transitions to other depths within the image. In addition, edge smoothing may be utilized over a sequence of images such as a motion picture to prevent scintillation for example. Feathering is also known as vignetting wherein the border of an area is blended with the background image over a transitionary distance, e.g., number of pixels. In other embodiments of the invention, transparency along the edges of an area may be utilized in combination with a depth gradient to produce a three-dimensional feathering functionality. For example, this allows for more natural appearance of hair or leaves where masking these objects individually would require great effort. Gradients for depth allows for walls at an angle to appear to proper travel to and away from the observer. Gradients may be accepted into the system in any form, such as linear, or curved in any form to quickly allow for the representation of depth in a two-dimensional image. For example layer based setting of depths may be accomplished via layer pane 305. Any other drawing based methods of entering gradients or feathering for example may be utilized in combination with depth map 200.

Embodiments of the invention also allow for any type of graphical effect including erosion or dilation for example. Any other graphical effect may also be utilized with embodiments of the invention. For example, motion of the two viewpoints to and away, across or around a scene may be performed by adjusting the calculated viewpoints. In this manner, a simulated camera pan resulting in a three-dimensional viewing of an image as a sequence of images is performed. All parameters related to the cameras may be calculated and altered using embodiments of the invention. This allows for different focal lengths, camera displacements and offsets to be utilized when generating output images. In any embodiments of the invention, when empty background areas would result from one or more camera viewpoints, foreground objects (anything in front of infinity for example), may be enlarged to cover these empty areas wherein the foreground objects may be maintained in their enlarged size for an entire scene for example. Depths for areas of an image may also be animated over time, for example when a character or object moves towards or away from the camera. This allows for motion pictures to maintain the proper depth visualization when motion occurs within a scene.

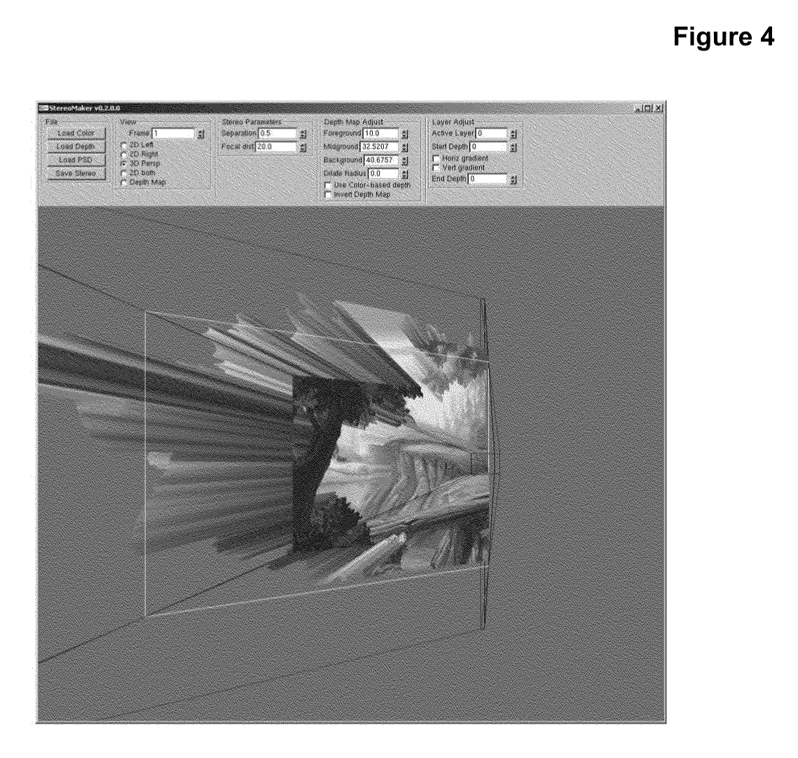

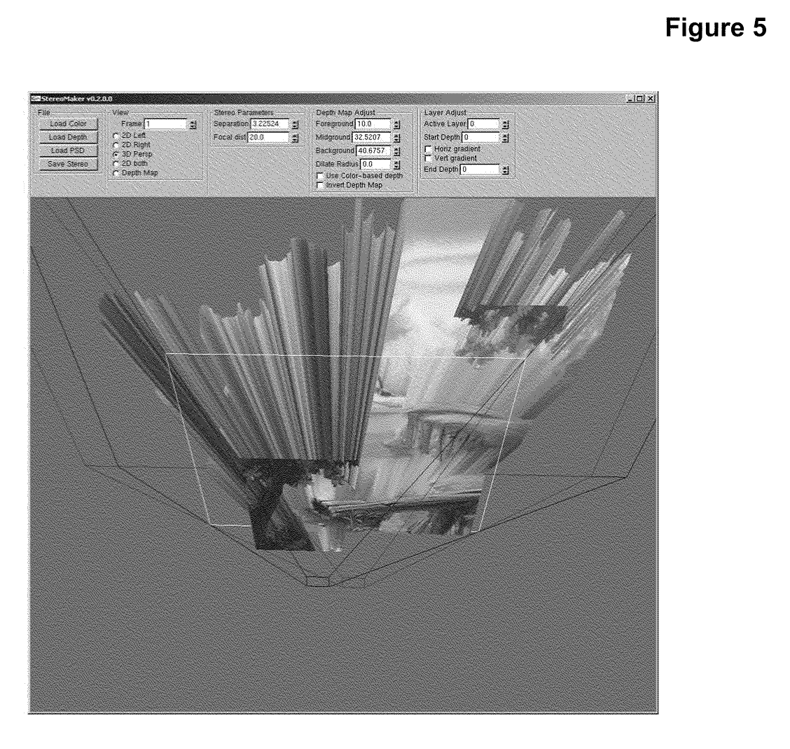

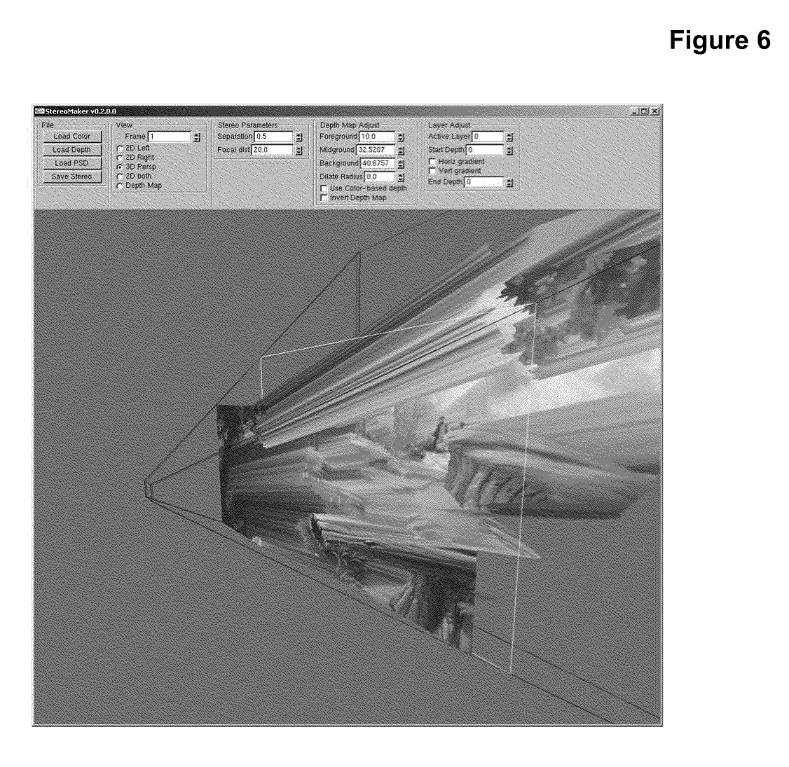

FIG. 4 shows a view of the image viewed in FIG. 3 rotated to the right to further illustrate the depths of various areas assigned to the image. FIG. 5 shows a view of the image viewed in FIG. 3 rotated down to further illustrate the depths of various areas assigned to the image. FIG. 6 shows a view of the image viewed in FIG. 3 rotated to the left to further illustrate the depths of various areas assigned to the image.

FIG. 7 shows second image 100a with foreground objects of the first image shifted and enlarged to cover empty areas shown as ray intersections in the various depths as per FIGS. 3-6. By viewing the left image with the left eye and the right image with the right eye, a three-dimensional view of single image 100 is thus observed. FIG. 8 shows the upper left quadrant of an alternate output format where the first and second images form a pair of offset images that are overlaid onto one another with varying colors in the form of an anaglyph. As objects nearer the observer generally larger and have larger offsets than background objects, it is readily observed that tree 102a and 102b are actually offset images in different colors represent tree 102 in FIG. 1 from different viewpoints.

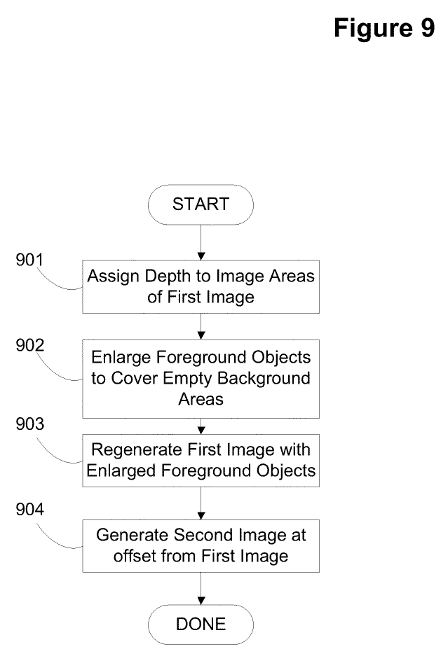

FIG. 9 shows a flowchart for an embodiment of the method. Depth information is assigned to areas of an image at 901. Any format of digitized image may be utilized by the system. The camera offsets utilized and distance away from objects in the image determines the empty background areas that are to be accounted for utilizing embodiments of the invention. The system enlarges foreground objects from the first image to cover empty background areas that would be displayed in the second image if the foreground objects were not enlarged at 902. The first image is then regenerated with the foreground objects enlarged at 903 even though there are no empty background areas in the first image since it is the viewpoint from which the first image was captured. The second image is generated from the assigned viewpoint and offset of the second camera at 904 using the enlarged foreground objects to match the enlarged foreground objects in the first figure, albeit with foreground objects translated in the axis between the two cameras. The foreground objects are enlarged enough to cover any empty background areas that would have occurred had the foreground objects not been enlarged. Any method of viewing the resulting offset image pair, or anaglyph image created from the pair is in keeping with the spirit of the invention.

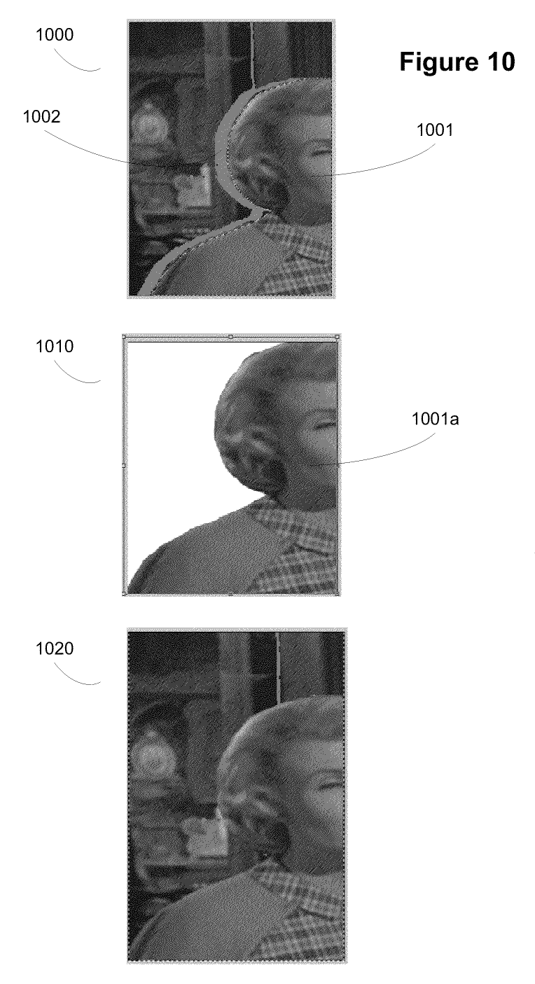

FIG. 10 shows foreground object 1001 with empty background area 1002 in frame 1000 before scaling and translating foreground object 1001 to produce an enlarged foreground object 1001a to cover empty background area 1002. Specifically, foreground object 1001 as viewed from the left eye would display empty background 1002 when the foreground objects are translated to locations based on a depth map for example. As empty background area 1002 may contain data that is not in any other frame in a scene, embodiments of the invention eliminate this area by scaling foreground object 1001 to produce a slightly enlarged foreground object 1001a as shown in scale window 1010. Foreground object 1001a is then utilized to cover foreground object 1001 while maintaining proper proportions of foreground object 1001, yet cover empty background area 1002, that is no longer visible in frame 1020. Foreground object 1001a is also applied to the original image and although foreground object 1001 is now slightly enlarged in proportion, there are no empty background area artifacts and the resulting size difference is generally not noticeable.

Embodiments of the invention may use pre-existing digital masks that exist for movies. One such source of digital masks is movies that have been colorized. Colorized movies generally utilize digital masks that are either raster or vector based areas that define portions of a movie where a palette of color is to be applied. As these masks generally define human observable objects that also are associated by the human mind at a given depth, these masks may be utilized by embodiments of the invention to augment the depth of an image. The enormous effort of generating masks for an entire movie may thus be leveraged. In addition, through use of existing masks, the merging and splitting of masks to facilitate depth augmentation allows for the combining of masks at a similar depth to simplify the tracking of masks through frames wherein the masks define different color areas on an object, but which are all at about the same depth for example. This allows for a mask of a face for example, where eye colors and lip colors utilize masks that define different colors but which are at about the same depth on a face. In addition, splitting masks that have been defined for objects that were the same color for example but which are at different depths allows for use of these existing mask outlines, and providing further information to aid in augmenting the depth. For example, two faces that might have the same color applied to them, but which are at different offsets may be split by embodiments of the invention in order to apply separate depths to each face. Furthermore, the edges of these masks, or any other masks utilized for depth augmentation where or not used from existing mask data sets may be dithered with various depths on the edges of the masked objects to make the objects look more realistic.

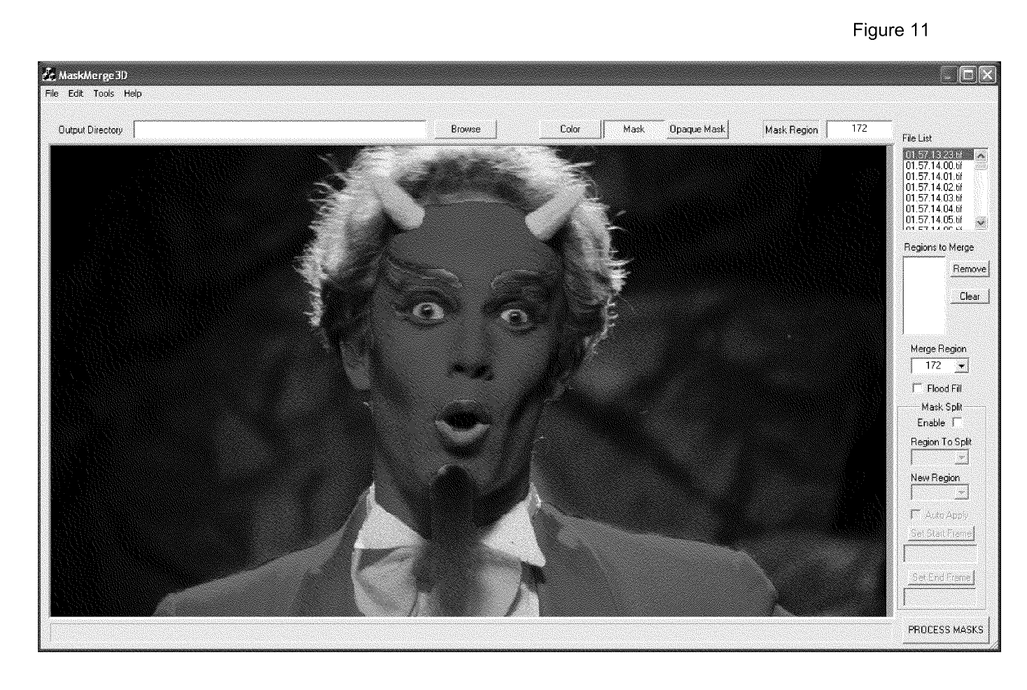

FIG. 11 shows an image frame from a movie with masks shown in different colors imposed on a grey-scale underlying image. The mask for the eyes of the face shown in the figure is colored separately from the lips. For colorization projects this results in separate palettes utilized for different areas of an object that may actually be at the same depth from the camera.

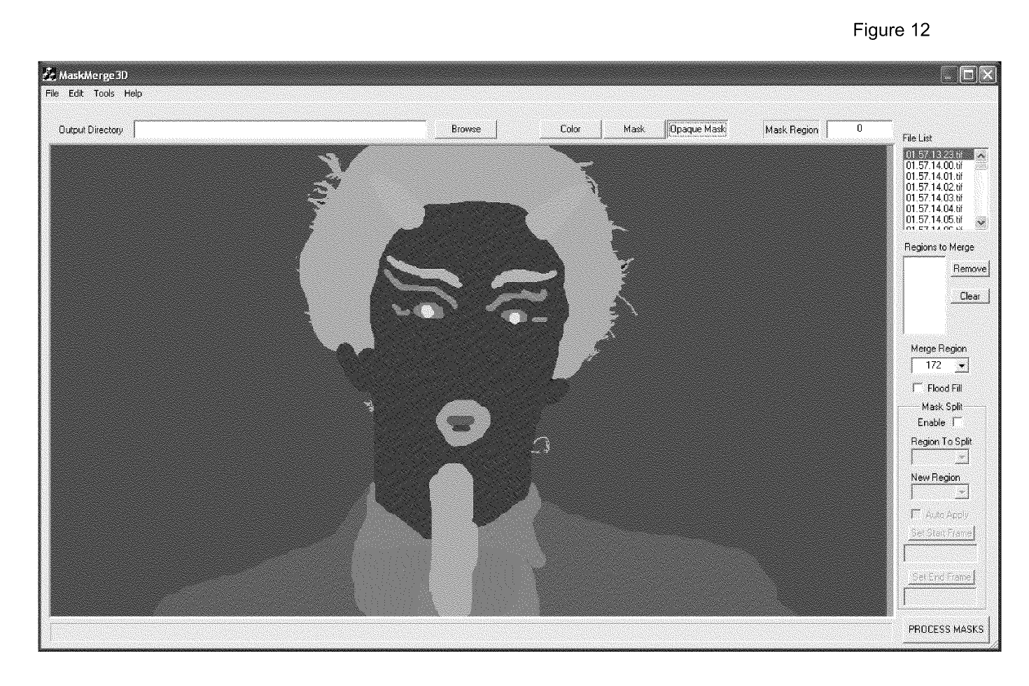

FIG. 12 shows the image frame from FIG. 11 without the underlying grey-scale image, i.e., shows the opaque masks.

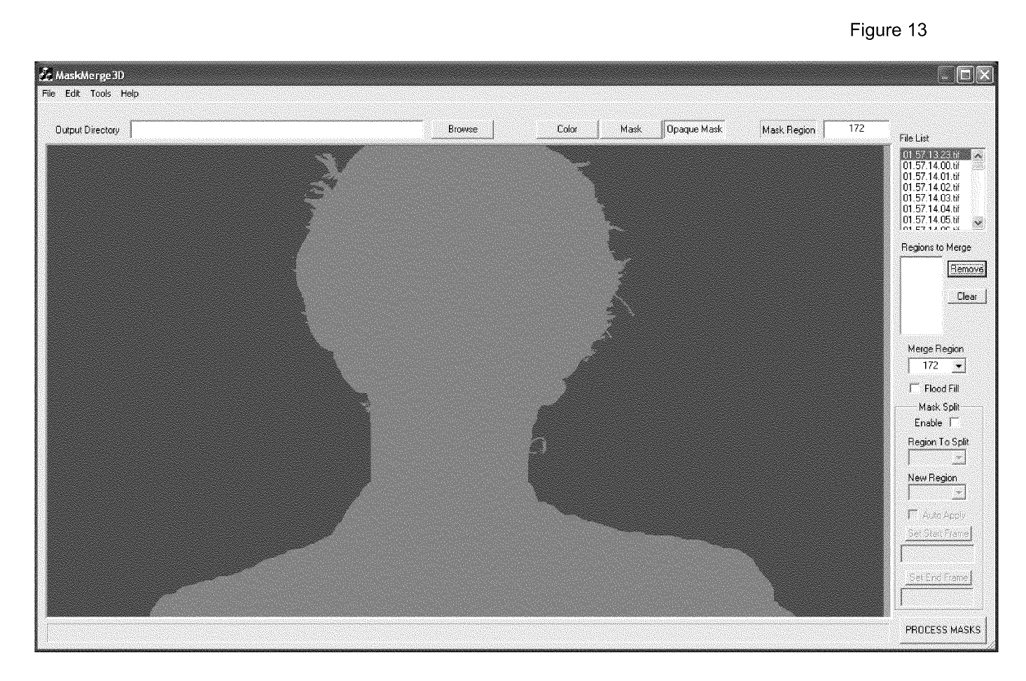

FIG. 13 shows the merge of the masks of FIG. 12 into one image for application of depth primitives on and tracking of the mask through frames in a scene. In this case, depth primitives, gradients and other depth assignments as shown in FIG. 2 may thus be applied to the merged mask of FIG. 13. For example an ellipsoid may be applied to make the edges of the merged mask further away from the camera viewpoint. In addition, the merged mask may be drawn on with a grey scale paint brush to create nearer and further away portions of the associated underlying image.

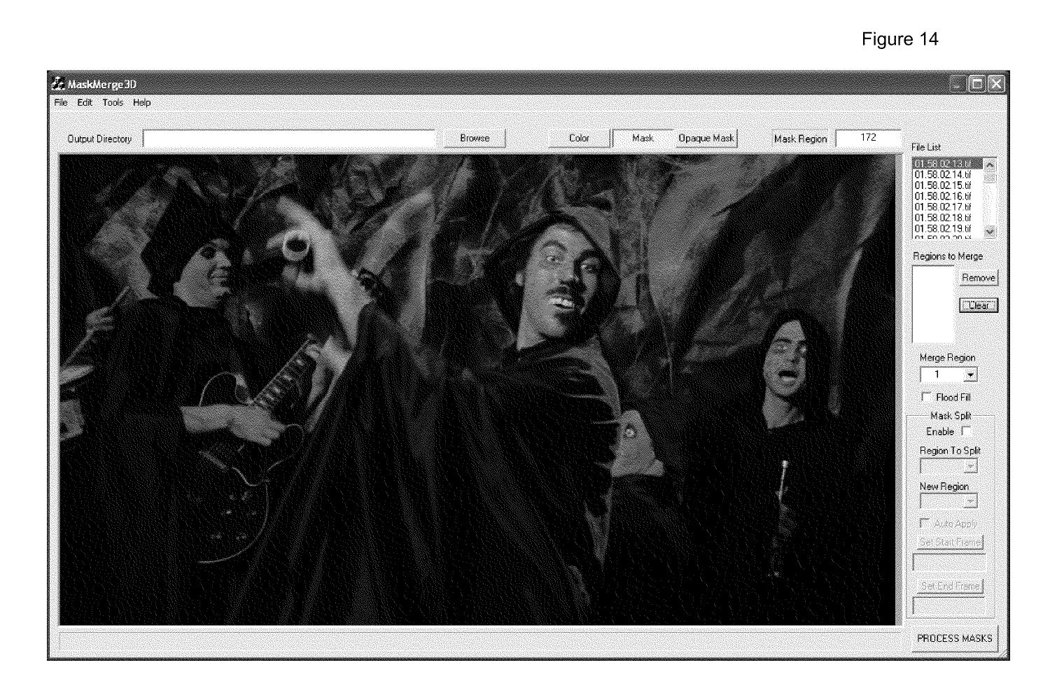

FIG. 14 shows an image frame from a movie with masks shown in different colors imposed on a grey-scale underlying image. In this case, faces that would be defined as a given color may be split to assign different depths to the faces, when an original colorized frame may utilize one mask for all three faces to apply color.

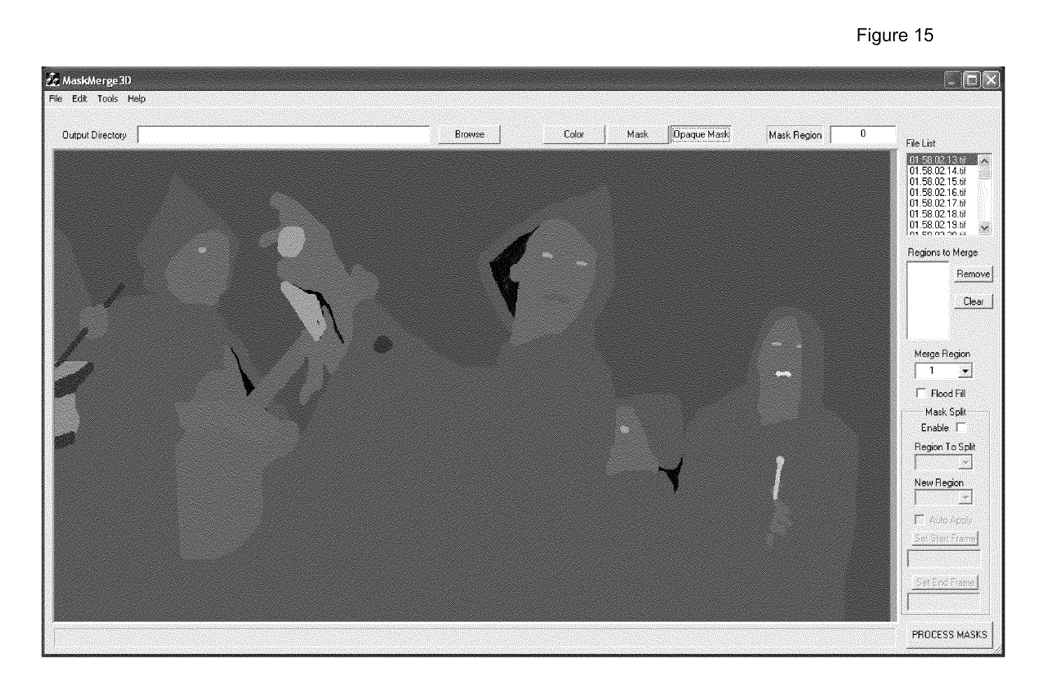

FIG. 15 shows the opaque masks of FIG. 14.

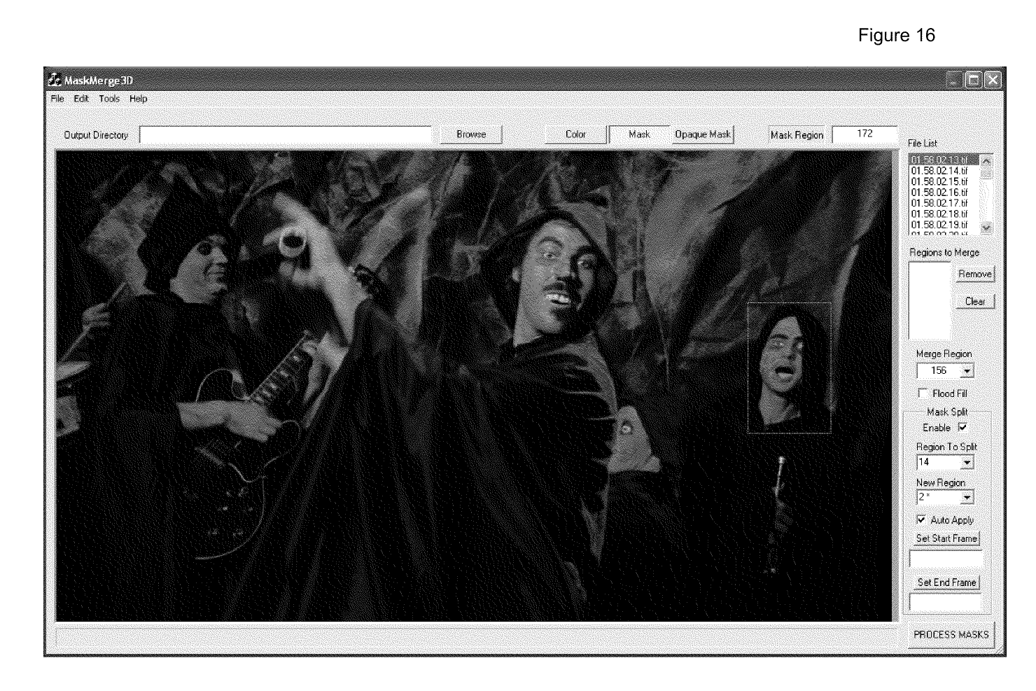

FIG. 16 shows the selection of an area to split masks in.

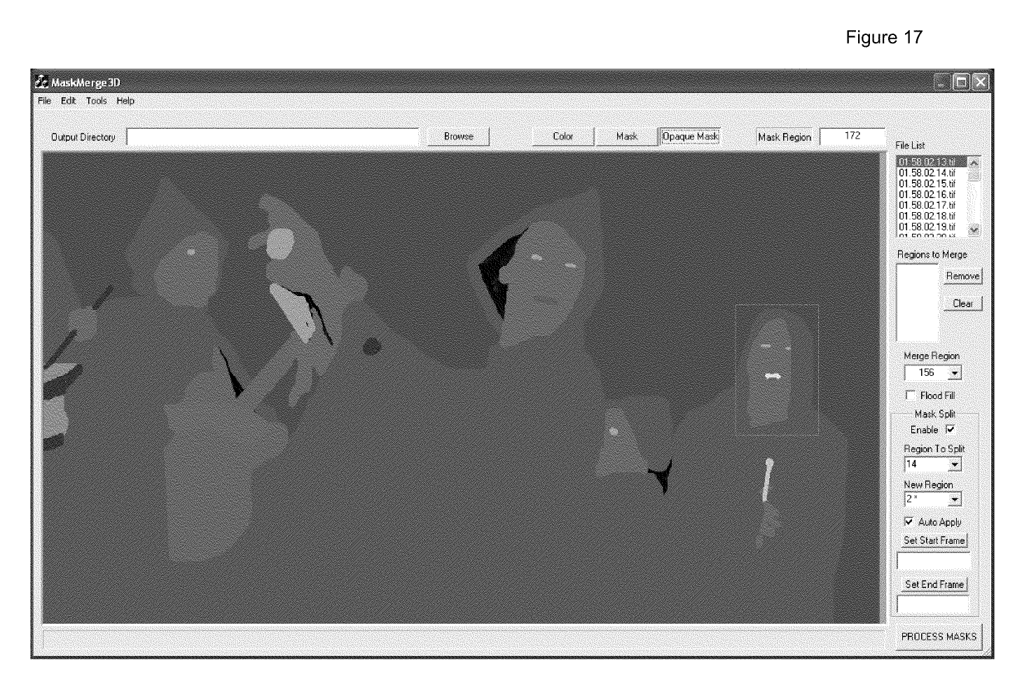

FIG. 17 shows the selection of an area of the opaque masks of FIG. 16 as per the rectangular selection area around the rightmost mask.

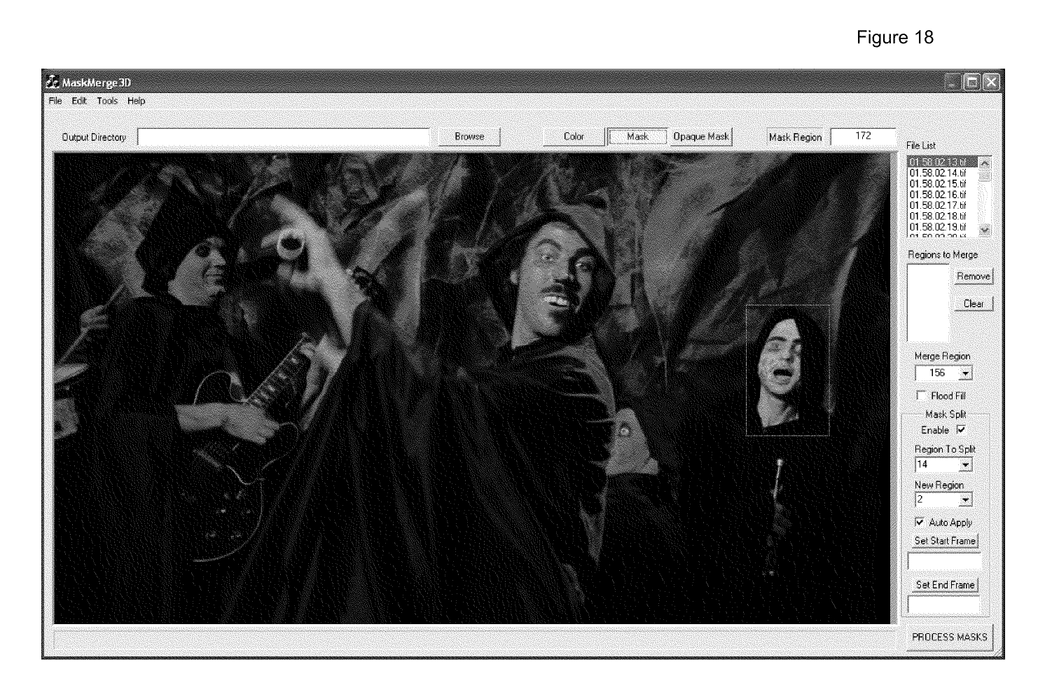

FIG. 18 shows the split mask imposed on the grey-scale underlying image, now showing the rightmost face assigned to a different depth.

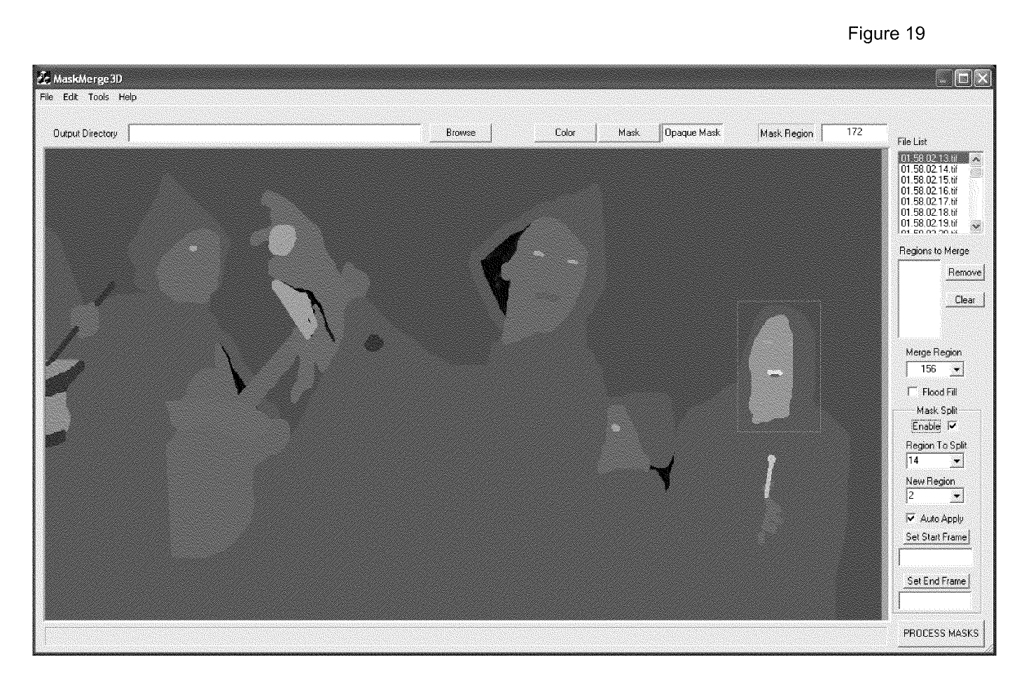

FIG. 19 shows the split mask assigned to a different depth level that the other faces in the figure without the underlying grey-scale images.

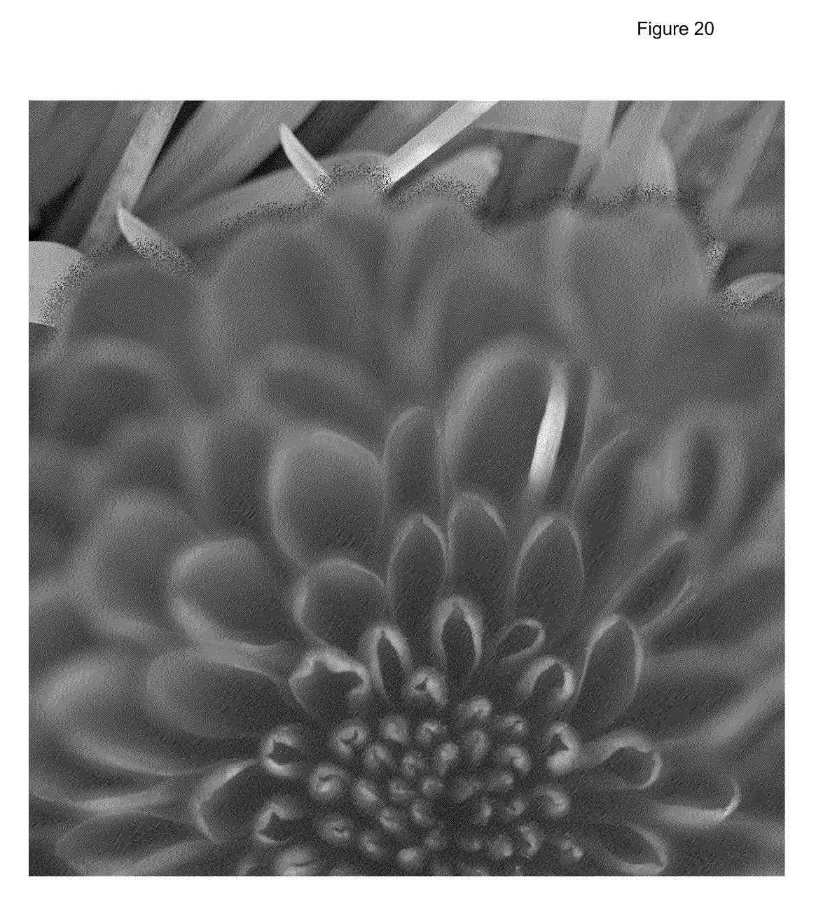

FIG. 20 shows a dithered depth edge of a flower for more realistic viewing. In this figure, the edges of the flower may be dithered wherein the individual flower dithered pixels and small areas off of the main flower may be assigned various depths to provide a more realistic soft edge to the depth augmented object. This effect can also be utilized for existing digital masks that are object for example from colorization projects.

While the invention herein disclosed has been described by means of specific embodiments and applications thereof, numerous modifications and variations could be made thereto by those skilled in the art without departing from the scope of the invention set forth in the claims.

What is claimed is:

1. An image depth augmentation method for providing three-dimensional views of a two-dimensional image comprising:
assigning depth information from a depth map to areas in a first image captured from a first viewpoint;
enlarging foreground objects to cover empty background areas based on an offset distance to a second viewpoint;
regenerating said first image with foreground objects enlarged; and,
generating a second image at said second viewpoint displaced by said offset distance with respect to said first image comprising said foreground objects that have been enlarged to yield a pair of offset images for three-dimensional viewing wherein said empty background areas are covered in said second image.
